(19) United States
(12) Patent Application Publication
(10) Pub. No.: US 2017/0183790 A1
(43) Pub. Date: Jun. 29, 2017

(54) PROCESS FOR PURE ALUMINUM PRODUCTION FROM ALUMINUM-BEARING MATERIALS

(71) Applicant: PROCEDE ETHANOL VERT TECHNOLOGIE, Brossard (CA)

(72) Inventor: Joël FOURNIER, Brossard (CA)

(73) Assignee: PROCEDE ETHANOL VERT TECHNOLOGIE, Brossard (CA)

(21) Appl. No.: 15/313,991

(22) PCT Filed: May 26, 2015
(86) PCT No.: PCT/CA2015/050475

§ 371 Date: Nov. 25, 2016

Related U.S. Application Data
(60) Provisional application No. 62/002,986, filed on May 26, 2014.

(51) Int. Cl. C25C 1/02; C22B 1/24; C01B 33/12; C22B 3/44; C22B 3/22; C01F 7/56; C22B 21/00; C22B 3/10

(52) U.S. Cl. CPC C25C 1/02; C22B 21/0007; C22B 21/0015; C22B 21/0046; C22B 1/24; C22B 3/10; C22B 3/44; C22B 3/22; C01F 7/56; C01B 33/126

(57) ABSTRACT

It is described a process for extracting aluminum from aluminum-bearing materials comprising the steps of leaching the aluminum-bearing material with HCl to obtain aluminum chloride; separating and purifying the aluminum chloride; providing aluminum chloride to an electrolysis cell comprising an anode connected to a source of hydrogen gas delivering the hydrogen gas during use to the anode, and a cathode; passing an electric current from the anode through the cathode, depositing aluminum at the cathode; and draining the aluminum from the cathode.

### TECHNICAL FIELD

The present disclosure relates to the extraction of aluminum from aluminum-bearing materials.

### BACKGROUND ART

Pure aluminum (Al) is a silver-white, malleable, ductile metal with one-third the density of steel. It is the most abundant metal in the earth's crust. Aluminum is an excellent conductor of electricity and has twice the electrical conductance of copper. It is also an efficient conductor of heat and a good reflector of light and radiant heat.

Unlike most of the other major metals, aluminum does not occur in its native state, but occurs ubiquitously in the environment as silicates, oxides and hydroxides, in combination with other elements such as sodium and fluoride, and as complexes with organic matter. When combined with water and other trace elements, it produces the main ore of aluminum known as bauxite.

Bauxite is an aluminium ore and is the main source of aluminium. This form of rock consists mostly of the minerals gibbsite Al(OH)₃, boehmite γ-AlO(OH), and diaspore α-AlO(OH), in a mixture with the two iron oxides goethite and hematite, the clay mineral kaolinite, and small amounts of anatase TiO₂.

Bauxite is usually strip mined because it is almost always found near the surface of the terrain, with little or no overburden. Approximately 70% to 80% of the world's dry bauxite production is processed first into alumina, and then into aluminium by electrolysis. Bauxite rocks are typically classified according to their intended commercial application: metallurgical, abrasive, cement, chemical, and refractory. Usually, bauxite ore is heated in a pressure vessel along with a sodium hydroxide solution at a temperature of 150 to 200° C. At these temperatures, the aluminium is dissolved as an aluminate following the Bayer process. After separation of ferruginous residue (red mud) by filtering, pure gibbsite is precipitated when the liquid is cooled, and then seeded with fine-grained aluminium hydroxide. The gibbsite is usually converted into aluminium oxide, Al₂O₃, by heating. This mineral becomes molten at a temperature of about 1000° C., when the mineral cryolite is added as a flux. Next, this molten substance can yield metallic aluminium by passing an electric current through it in the process of electrolysis, which is called the Hall-Héroult process after its American and French discoverers in 1886. Prior to the Hall-Héroult process, elemental aluminium was made by heating ore along with elemental sodium or potassium in a vacuum. The method was complicated and consumed materials that were themselves expensive at that time. This made early elemental aluminium more expensive than gold.

In the Hall-Héroult process, a molten mixture of alumina (Al₂O₃), cryolite (sodium hexafluoroaluminate —Na₃AlF₆), and aluminum fluoride (AlF) is placed into an electrolytic cell, and a direct current is passed through the mixture. The electrochemical reaction causes liquid aluminum metal to be deposited at the cathode as a precipitate, while the oxygen from the aluminum combines with carbon from the anode to produce carbon dioxide (CO₂). The overall chemical reaction is: 2Al₂O₃+3C→4Al+3CO₂. The alumina used in the Hall-Héroult process is commonly conventionally obtained by refining bauxite (which contains typically between 30-50% alumina) via the well-known Bayer process, which itself was invented in 1887.

In the Bayer process, bauxite is digested by washing with a hot solution of sodium hydroxide, NaOH, at 175° C. This converts the aluminium oxide in the ore to sodium aluminate, 2NaAl(OH)₄, according to the chemical equation: Al₂O₃+2 NaOH+3 H₂O→2 NaAl(OH)₄. The other components of bauxite do not dissolve. The solution is clarified by filtering off the solid impurities. The mixture of solid impurities is called red mud, and presents a disposal problem. Next, the alkaline solution is cooled, and aluminium hydroxide precipitates as a white, fluffy solid: NaAl(OH)₄→Al(OH)₃+NaOH. Then, when heated to 980° C. (calcined), the aluminium hydroxide decomposes to aluminium oxide, giving off water vapor in the process: 2 Al(OH)₃→Al₂O₃+3 H₂O. A large amount of the aluminium oxide so produced is then subsequently smelted in the Hall-Héroult process in order to produce aluminium.

Thus presently, aluminum is produced by separating pure alumina from bauxite in a refinery, then treating the alumina by electrolysis. An electric current flowing through a molten electrolyte, in which alumina has been dissolved, separates the aluminum oxide into oxygen, which collects on carbon anodes immersed in the electrolyte, and aluminum metal, which collects on the bottom of the carbon-lined cell (cathode). On average, it takes about 4 t of bauxite to obtain 2 t of aluminum oxide, which in turn yields 1 t of metal.

Thus, for over 120 years, the Bayer process and the Hall-Héroult process together have been the standard commercial method of the production of aluminum metal. These processes require large amounts of electricity and generate undesired by products, such as fluorides in the case of the Hall-Héroult process and red mud in the case of the Bayer process.

WO2014/075173 and WO2015/042692 are example of processes described in the art wherein aluminum is purified from aluminum containing material through the production of Al₂O₃.

There is thus still a need to be provided with improved processes for extracting aluminum from aluminum-bearing materials such as bauxite.

### SUMMARY

In accordance with the present description there is now provided a process for extracting aluminum from an aluminum-bearing material comprising the steps of leaching the aluminum-bearing material with HCl to obtain a leachate containing aluminum chloride; separating and purifying the aluminum chloride; providing aluminum chloride to an electrolysis cell comprising an anode connected to a source of hydrogen gas delivering the hydrogen gas during use to the anode, and a cathode; passing an electric current from the anode through the cathode, depositing aluminum at the cathode; and draining the aluminum from the cathode.

In an embodiment, the process described herein further comprises the steps of sparging the aluminum chloride with gaseous hydrogen chloride into a crystallizer to produce aluminum chloride hexahydrate solid and dehydrating said aluminum chloride hexahydrate under HCl atmosphere to generate the aluminum chloride.

In another embodiment, the process described herein further comprises the step of evaporating the aluminum chloride prior or after the sparging step to obtain a precipitate comprising the aluminum chloride hexahydrate.

In a further embodiment, the evaporating step is conducted by using a multi-effect forced circulation evaporator and settlement separation; a settlement separation and a flash evaporation crystallization; or a vacuum flash evaporation.

In an embodiment, the process described herein further comprises the step of decanting the aluminum chloride prior to evaporating or sparging.

In another embodiment, the process described herein further comprises the step of filtrating the aluminum chloride prior or after decanting the leachate.

In a supplemental embodiment, the process described herein further comprises the step of a solid/liquid separation the solid aluminum chloride hexahydrate.

In an embodiment, the solid/liquid separation is accomplished by at least one of filtration, gravity, decantation, and vaccum filtration.

In another embodiment, the process described herein further comprises recycling the HCl by at least one of hydrolysis, pyrohydrolysis and liquid/liquid extraction.

In a further embodiment, the HCl is recycled using a Spray Roaster Pyrohydrolysis or a Fluidised Bed Pyrohydrolysis.

In a further embodiment, the HCl recycled has a concentration of about 25 to about 45 weight %.

In a supplemental embodiment, the aluminum chloride hexahydrate is dehydrated by contacting the hexahydrate with a melt comprising a chlorobasic mixture of at least one alkali metal chloride and aluminum chloride at a temperature within the range of about 160° C.-250° C. forming gaseous HCl and an oxychloroaluminate-containing reaction mixture; contacting the reaction mixture with gaseous HCl at a temperature within the range of about 160° C.-250° C. to form and release water from the reaction mixture; and recovering a melt enriched in aluminum chloride.

In a further embodiment, the aluminum chloride hexahydrate is dehydrated by heating the aluminum chloride hexahydrate at 200° C.-450° C. decomposing the hexahydrate; and reacting the decomposed hexahydrate with a chlorine containing gas at 350° C.-500° C. producing anhydrous aluminum chloride.

In another embodiment, the aluminum chloride hexahydrate is dehydrated by heating the hexahydrate at 100° C.-500° C. to remove water; and heating this material at 600° C.-900° C. to producing anhydrous aluminum chloride.

In an embodiment, the process described herein further comprises the step of separating silica from the leachate.

In another embodiment, the process described herein further comprises the step of crushing the aluminum-bearing material prior to leaching.

In an embodiment, the aluminum-bearing material is crushed to an average particle size of about 50 to 80 μm.

In another embodiment, the process described herein further comprises the step of cycloning the crushed aluminum-bearing material.

In an embodiment, the process described herein further comprises the step of a magnetic separation of the crushed aluminum-bearing material.

In a supplemental embodiment, the source of hydrogen gas is a reactor.

In another embodiment, the reactor is a steam methane reformer.

In another embodiment, the reactor uses partial oxidation, plasma reforming, coal gasification or carbonization to produce hydrogen gas.

In another embodiment, the aluminum-bearing material is at least one of bauxite, fly ash, scrap metal, clays, argillite, mudstone, beryl, cryolite, garnet, spinel, nepheline-syenites, nepheline-apatites, alunites, leucitic lavas, labradorites, anorthosites, kaolins, cyanitic, sillimanitic, mica and andalusitic schists.

In a further embodiment, the bauxite is low grade bauxite

### BRIEF DESCRIPTION OF THE DRAWINGS

Reference will now be made to the accompanying drawings, showing by way of illustration:

FIG. 1 shows a bloc diagram of a process according to one embodiment for extracting aluminum from a aluminum-bearing material.

### DETAILED DESCRIPTION

It is provided a process for extracting aluminum from aluminum-bearing materials using hydrochloric acid which is recycled during the process.

The process described herein provides a new way to produce pure AlCl₃ by an hydrometallurgy process instead of carbochlorination conventional method and an improve electrolytic process to reduce the energy consumption versus the Hall-Héroult process.

AlCl₃ sublimation point is 180° C. It can be used for electrodeposition at low temperature in different types of electrolyte: chlorine-based salts or ionic liquids. Although production of aluminum by electrolysis of aluminum chloride offers certain potential advantages over the Hall-Héroult process, such as operation at lower temperature and avoidance of consumption of carbon electrodes through oxidation by oxygen evolved in electrolysis of alumina, disadvantages have outweighed such advantages and production of aluminum by electrolysis of aluminum chloride has not been commercially adopted. Major problems which have effectively precluded commercially economical continuous electrolysis of aluminum chloride dissolved in molten salts at above the melting point of aluminum stem from the presence of metal oxides such as alumina, silica, titania, and the like in the electrolytic bath. Metal oxides in the bath, and particularly undissolved metal oxides, are a primary factor in causing a gradual accumulation on cell cathodes of a viscous layer of finely divided solids, liquid components of the bath, and droplets of molten aluminum.

In accordance with the present description there is now provided a process for extracting aluminum from an aluminum-bearing material comprising the steps of leaching the aluminum-bearing material with HCl to obtain a leachate containing aluminum chloride; separating and purifying the aluminum chloride; providing aluminum chloride to an electrolysis cell comprising an anode connected to a source of hydrogen gas delivering the hydrogen gas during use to the anode, and a cathode; passing an electric current from the anode through the cathode, depositing aluminum at the cathode; and draining the aluminum from the cathode.

There are a large number of minerals and rocks containing aluminum; however, only a few of them can be used for extracting metallic aluminum. Bauxites are the most widely used raw materials for aluminum, including low grade bauxite. Initially a semi finished product, alumina (Al₂O₃) is extracted from the ores, and the metallic aluminum is produced electrolytically from the alumina.

Low grade bauxite is bauxite with high silica content and a lower percentage of alumina content that occurs just above the bauxite layers at the mines. It is used as a raw material by cement industries as an additive/flux to increase the alumina percentage in the cement composition.

Nepheline-syenites as well as nepheline-apatites are also used as aluminum ores. These minerals are simultaneously used as a source of phosphates. Other minerals which can be used as a source of aluminum include alunites, leucitic lavas (the mineral leucite), labradorites, anorthosites, and high-alumina clays and kaolins, as well as cyanitic, sillimanitic, and andalusitic schists.

The aluminum-containing materials can be for example chosen from aluminum-bearing ores (such as bauxite, low grade bauxite, clays, argillite, mudstone, beryl, cryolite, garnet, spinel, nepheline-syenites, nepheline-apatites, alunites, leucitic lavas, labradorites, anorthosites, kaolins, cyanitic, sillimanitic, mica and andalusitic schists, or mixtures thereof can be used). The aluminum-containing material can also be a recycled industrial aluminum-containing material such as slag, fly ash and scrap metal.

Fly ash, also known as flue-ash, is one of the residues generated in combustion, mainly during combustion of coal. Fly ash is generally captured by electrostatic precipitators or other particle filtration equipment before the flue gases reach the chimneys of coal-fired power plants. Depending upon the source and makeup of the coal being burned, the components of fly ash vary considerably, but all fly ash includes substantial amounts of SiO₂, Al₂O₃, Fe₂O₃ and occasionally CaO. Fly ash typically contains alumina (Al₂O₃) concentrations ranging from 5-35%. It has been estimated as reported by the International Energy Agency that coal generates approximately 41% of the world's electricity and is a significant fuel source for many industrial thermal processes and that approximately 43% of alumina produced worldwide in 2011 was manufactured using coal as a fuel source (International Aluminium Institute). Up to this date, recycling of fly ash outside of cement processes is very limited.

The process described herein represents a novel way of recycling fly ash by extracting its aluminum content. It is provided a solution to the increasing concern of recycling fly ash for example due to increasing landfill costs and current interest in sustainable development. The process described herein represents an effective way for not only solving an environmental liability but also generating revenues for companies using coal-based thermal power.

The process describe herein allows processing and extracting aluminum from aluminum-bearing materials such as bauxite, low grade bauxite, clays, argillite, mudstone, beryl, cryolite, garnet, spinel, nepheline-syenites, nepheline-apatites, alunites, leucitic lavas, labradorites, anorthosites, kaolins, cyanitic, sillimanitic, mica, andalusitic schists, slag, fly ash and scrap metal, or mixtures thereof.

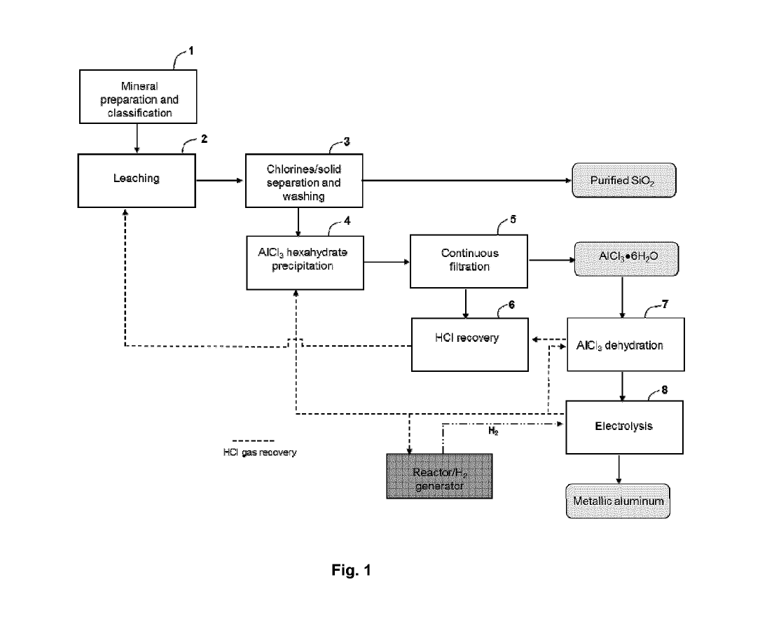

As can be seen from FIG. 1, and according to one embodiment, the process comprises a first step of preparing and classifying the mineral starting material.

### Preparation and Classification (Step 1)

Generally, the starting material can be finely crushed in order to facilitate the following steps. For example, as used commonly in the art, the starting material is reduced to an average particle of about 50 to 80 μm. For example, micronization can shorten the reaction time by few hours (about 2 to 3 hours).

The crushed materials could be for example cyclone to further eliminate undesired particles. The principle of cycloning consists in separating the heavier and lighter materials apart. A cyclone is a conical vessel in which particles are pumped tangentially to a tapered inlet and short cylindrical section followed by a conical section where the separation takes place. The higher specific gravity fractions being subject to greater centrifugal forces pull away from the central core and descend downwards towards the apex along the wall of cyclone body and pass out as rejects/middlings. For example, in the case of fly ash, the lighter particles are caught in an upward stream and pass out as clean coal through the cyclone overflow outlet via the vortex finder.

The classified and prepared material can subsequently further proceed to magnetic separation. The general purpose of this step is to increase the yield of the process and also specifically at this stage to remove the iron, steel and nickel-based alloys present in the starting material. Drum magnets, Eddy current separators and overhead belt magnets can be used for example at this step to separate aluminum and other non-ferrous metals from the process stream.

### Acid Leaching (Step 2)

The crushed materials then undergo acid leaching to dissolve the alumina containing fraction from the inert fraction of the material. Acid leaching comprises reacting the crushed classified materials with a hydrochloric acid solution at elevated temperature during a given period of time which allows dissolving the aluminum and other elements. For example, the silica and titania (TiO₂) remains undissolved after leaching.

The step of leaching the aluminum-containing material with HCl is accomplished to obtain a leachate comprising aluminum ions and a solid. The solid is separated afterwards from the leachate.

### Chlorines/Solid Separation and Washing (Step 3)

As mentioned, the solid fraction is separated from the leachate by decantation and/or by filtration, after which it is washed. The corresponding residue can thereafter be washed many times with water so as to decrease acidity. The residual leachate and the washing water may be completely evaporated.

The solid obtain can contain residual alumina, hematite (Fe₂O₃), silica (SiO₂), and titania (TiO₂) or other non leached metal and non-metal.

At this stage, a separation and cleaning step can be incorporated in order to separate the purified silica from the metal chloride in solution. Pure silica (SiO₂) is recuperated. The recovered highly pure silica can then be used in the production of glass and of optical fibers for example.

In an embodiment, the process can comprise separating the solid from the leachate and washing the solid so as to obtain silica.

### AlCl₃ Hexahydrate Precipitation (Step 4)

The spent acid (leachate) containing the metal chloride in solution obtained from step 3 can then be brought up in concentration. Sparging in a crystallizer using HCl can be used for example to increase the concentration of the spent acid. Reacting the leachate with HCl allows to obtain a liquid and a precipitate comprising the aluminum ions in the form of AlCl₃.6H₂O, which can be separated from the liquid. This can result into the precipitation of aluminum chloride as an hexahydrate. When the leachate is treated with dilute hydrochloric acid, a solution is obtained that contains aluminum and other soluble constituents of the starting materials in the form of chlorides. Crystallization as the hydrated chloride, AlCl₃.6H₂O serves to separate the aluminum from the other soluble chlorides.

Crystallization is effected by the sparging technique which utilizes the common ion effect to reduce the solubility of ACl₃ in the process liquor. The process liquor is evaporated to near saturation by using a recirculating heat exchanger and vacuum flash system similar to that used for evaporative crystallization. The evaporation increases the aluminum chloride concentration.

The sparging step can also be conducted before or after an evaporation step as known in the art which consist of evaporating the solution until a slurry of crystals is formed so as to separate the hydrated aluminum chloride. Evaporating the leachate with HCl allows also to obtain a liquid and a precipitate comprising the aluminum ions in the form of AlCl₃.6H₂O, which can be separated from the liquid phase. The evaporation step can be specifically conducted for example by using a multi-effect forced circulation evaporator followed by performing settlement separation, performing settlement separation on solid crystals of aluminum chloride hexahydrate and performing flash evaporation crystallization, sending the solution containing solid crystals of aluminum chloride obtained by the settlement separation step to a flash evaporation crystallization tank and performing vacuum flash evaporation on the solution under the condition that the temperature is between 60 and 75° C. and the vacuum degree is 0.095 to 0.08 MPa (see CN 101837998 for example).

A major purpose of aluminum chloride hexahydrate crystallization and evaporation is to separate aluminum from acid-soluble impurities. This step could be repeated one or many time in other to improve the purity of the aluminum chloride.

Finally, performing crystallization filtration will convey the discharged materials obtained by the evaporation/crystallization step to a filter for filtrating.

### Continuous Filtration (Step 5)

In order to increase the yield of precipitation of aluminum chloride, aluminum chloride hexahydrate solid is obtained following a solid/liquid separation by for example, filtration, gravity, decantation, and/or vacuum filtration. A slurry of aluminum chloride is remove and the liquid portion undergoes continuous filtration to increase the yield of recovery of slurry containing aluminum chloride hexahydrate crystals.

HCl Recovery (step 6)

As seen in FIG. 1, multiple loops of reintroducing HCl recycled from the ongoing steps are present, demonstrating the capacity to recuperate the used HCl. For example, HCl can be recuperated at this stage by hydrolysis, pyrohydrolysis and/or liquid/liquid extraction. Metal chlorides unconverted are processed to a hydrolysis, or pyrohydrolysis step (700-900° C.) to generate mixed oxides and where hydrochloric acid can be recovered.

After hydrolysis or pyrohydrolysis (using Spray Roaster Pyrohydrolysis or Fluidised Bed Pyrohydrolysis for example), the recycled gaseous HCl so-produced is contacted with water so as to obtain a composition having a concentration of about 25 to about 45 weight % and reacted with a further quantity of aluminum-containing material so as to undergo a leaching step 2 or can be recycled back to the crystallization step 4.

Alternatively, sodium chloride present after the continuous filtration step 5 can be reacted with sulfuric acid so as to obtain sodium sulfate and regenerate hydrochloric acid at a concentration at or above the azeotropic point. Similarly, potassium chloride can be reacted with sulfuric acid so as to obtain potassium sulfate and regenerate hydrochloric acid at a concentration above the azeotropic concentration.

The acid recovered can be re-utilized after having adjusted its concentration either by adding gaseous HCl, or by adding concentrated HCl.

### AlCl₃ Dehydration (Step 7)

Aluminum chloride hexahydrate solid then undergoes a dehydration step under HCl atmosphere to form mono-hydrate, semi-hydrate or even anhydrous form of AlCl₃ before processing to the electrolysis to recuperate the purified metallic alimunum.

For example, as described in U.S. Pat. No. 4,493,784, one way for dehydrating aluminum chloride hexahydrate comprises contacting the hexahydrate with a melt consisting essentially of a chlorobasic mixture of at least one alkali metal chloride and aluminum chloride at a temperature within the range of about 160° C.-250° C. to form gaseous HCl and an oxychloroaluminate-containing reaction mixture and then contacting said reaction mixture with gaseous HCl at a temperature within the range of about 160° C.-250° C. to form and release water from the reaction mixture. Aluminum chloride is recovered in the form of an alkali metal chloride/aluminum chloride melt enriched in aluminum chloride. As such, the product is useful in processes for producing aluminum by the electrolytic reduction of aluminum chloride such as in step 8.

Alternatively, anhydrous aluminum chloride can also be produced as described in U.S. Pat. No. 4,264,569 by heating the aluminum chloride hexahydrate at 200° C.-450° C. until the hexahydrate is substantially decomposed and reacting the decomposed material with a chlorine containing gas at 350° C.-500° C. to produce anhydrous aluminum chloride. Another process comprises heating aluminum chloride hexahydrate at 100° C.-500° C. to remove water and HCl and to form a basic aluminum chloride and then heating this material at 600° C.-900° C. to produce anhydrous aluminum chloride.

### Electrolysis (Step 8)

It is one of the primary objective of the present disclosure to improve the production of aluminum by electrolysis of aluminum chloride, and particularly to increase the electrical efficiency of the electrolytic cells and otherwise reduce the cost of operation. The dehydrated aluminum chloride goes then through an electrolysis step using an anode as described in WO 2014/124539 comprising a hydrogen inflow to the anode. The production of aluminum from aluminum chloride, as illustrated in FIG. 1, results from the use of hydrogen gas available at the anode during the process. The chlorine atoms produced at the anode as a result of the electrolysis of the aluminum chloride will combine with the hydrogen atoms in the hydrogen gas to form hydrogen chloride (instead of combining with each other or with the carbon atoms in the graphite anode to form organo-chlorides—hydrogen being less electronegative than carbon). Thus the general reaction would become:

2AlCl₃+3H₂=2Al+6HCl

Accordingly, the reaction at the anode is:

H₂+Cl₂=2HCl

The use of such a device can result in substantial energy saving for electrolysis at 200° C. compared to the Hall-Héroult process at 650° C. according to:

2AlCl₃=2Al+3Cl₂ Eₒ=2V (at 200° C.)

2AlCl₃+3H₂=2Al+6HCl Eₒ=1V at (200° C.)

The use of a hydrogen gas diffusion anode provides a significant advantage over AlCl₃ conventional electrolysis but also again over a conventional Hall-Héroult process:

2Al₂O₃+3C→4Al+3CO₂ Eₒ=1.2V

Hydrogen chloride gas is an easier and less expensive gas to deal with than are the organo-chlorides and/or chlorine gas. Further, the production hydrogen chloride is recirculated in the process as described in FIG. 1. The HCl regenerated could be scrubed and reintroduce at the leaching part process or reuse for the precipitation of the AlCl₃ from the mother solution liquor or reuse for the AlCl₃ drying step.

Another potential benefit of the use of hydrogen gas as described above is that the hydrogen gas acts to lower the energy requirement for the electrolytic reaction. On the contrary, the Hall-Héroult process that uses pre-bake technology for producing aluminium needs periodic carbon anode replacement. This result in voltage instability, varying cell cavity geometry, and heat imbalance. Furthermore, greenhouse gases are formed as a by-product with the use of carbon anodes. The use of hydrogen as the reductant for electrowinning of aluminium has merits in that the total voltage requirement is less than that for a carbon anode while overcoming the disadvantages associated with the carbon electrode. The overall green house emission will be also reduced by the use of hydrogen.

Typical electrolytic can content LiCI, AlCl₃, NaCl, CaCl₂, MgCl₂, Na₃AlF₆, Li₃AlF₆, LiCI, LiF, K₃AlF₆, KCl, KF, BeCl₂, BACl₂ or in the case of deposition of highly corrosion resistant aluminum alloys: Al—Mn, Al—Cr, Al—Ti, Al—Cu, Al—Ni, Al—Co, Al—Ag, Al—Pt from NaCl melts or in the case of deposition of alloys using rare earth oxide LiCl—KCl—AlCl₃—Y₂O₃, LiCl—KCl—AlCl₃—Er₂O₃.

The hydrogen gas is provided by a reactor-generator. Such reactor-generator can be a steam methane reformer for example which produces hydrogen from hydrocarbon fuels such as natural gas, reacting steam at high temperatures with fossil fuel or lighter hydrocarbons such as methane, biogas or refinery feedstock into hydrogen and carbon monoxide (syngas). Syngas reacts further to give more hydrogen and carbon dioxide in the reactor.

Alternative ways of producing hydrogen consist in using partial oxidation, plasma reforming, coal gasification or carbonization for example.

Crushed scrap metals can also be used as a starting material, when leached with HCl to produce aluminum chloride and hydrogen which then goes through the electrolysis step (8). Aluminium dross residues can also be leached with HCl so as to obtain aluminum chloride and hydrogen.

Thus the electrolytic cell can be operated a lower voltage than would have otherwise have been the case if the hydrogen were not present. This reduces the total overall energy requirement related to the operation of the electrolytic cell, meaning that a cell with hydrogen gas present at the anode will be less expensive to operate than would have been the case had the hydrogen gas had been present. Another potential benefit of the use of hydrogen gas is that the chlorine atoms produced via the electrolytic reaction are all (assuming sufficient hydrogen gas is present) consumed in the production of the hydrogen chloride gas. This means that a graphite anode is not required to be used in the cell as the anode will not be consumed during the electrolytic reaction. Thus, assuming sufficient hydrogen is present, the anode can be made of any material otherwise compatible with the electrolytic cell operating environment. Non-limiting examples include anodes made of titanium or other forms of carbon.

The resulting metallic aluminum is extracted after electrolysis. The process of dehydrating aluminum chloride followed by the electrolysis step can be in a continuous loop such that the yield of extracted aluminum is increased.

The process described herein provides an efficient mean to produce aluminum from variable sources or materials, but also has the advantage of recuperating the HCl at multiple steps such that it is recycled back to ongoing steps. In combination with the use of an anode as described in WO 2014/124539, the process described herein provides a way of isolating aluminum from multiple sources without generating organo-chlorides which present risks to humans (and animals) and which may not be simply vented in the atmosphere. Expensive industrial processes (e.g. scrubbing) need to be implemented to deal with the undesired organo-chlorides which is not the case for the process described herein.

The process described herein represents an effective way for not only solving an environmental liability but also producing aluminum from other mineral sources than bauxite. It is also a way to generate revenues for companies using coal-based thermal power by using fly ash as a starting material.

While the invention has been described in connection with specific embodiments thereof, it will be understood that it is capable of further modifications and this application is intended to cover any variations, uses, or adaptations of the invention, and including such departures from the present disclosure as come within known or customary practice within the art to which the invention pertains and as may be applied to the essential features hereinbefore set forth, and as follows in the scope of the appended claims.

1. A process for extracting aluminum from an aluminum-bearing material comprising the steps of:
a. leaching the aluminum-bearing material with HCl to obtain a leachate containing aluminum chloride;
b. providing said aluminum chloride to an electrolysis cell comprising an anode connected to a source of hydrogen gas delivering the hydrogen gas during use to the anode, and a cathode;
c. passing an electric current from said anode through said cathode, depositing aluminum at said cathode; and
d. draining the aluminum from said cathode.

2. The process of claim 1, further comprising the steps of sparging the aluminum chloride with gaseous hydrogen chloride into a crystallizer to produce aluminum chloride hexahydrate solid and dehydrating said aluminum chloride hexahydrate under HCl atmosphere to generate the aluminum chloride.

3. The process of claim 2, further comprising evaporating the aluminum chloride prior or after the sparging step to obtain a precipitate comprising the aluminum chloride hexahydrate.

4. The process of claim 3, wherein the evaporating step is conducted by using a multi-effect forced circulation evaporator and settlement separation; a settlement separation and a flash evaporation crystallization; or a vacuum flash evaporation.

5. The process of claim 3, or further comprising the step of decanting the aluminum chloride prior to evaporating or sparging.

6. The process of claim 5, further comprising the step of filtrating the aluminum chloride prior or after decanting the leachate.

7. The process of claim 2, further comprising the step of a solid/liquid separation the solid aluminum chloride hexahydrate.

8. The process of claim 7, wherein the solid/liquid separation is accomplished by at least one of filtration, gravity, decantation, and vaccum filtration.

9. The process of claim 7, further comprising recycling the HCl by at least one of hydrolysis, pyrohydrolysis and liquid/liquid extraction.

10. The process of claim 9, wherein the HCl is recycled using a Spray Roaster Pyrohydrolysis or a Fluidised Bed Pyrohydrolysis.

11. The process of claim 9, wherein the HCl recycled has a concentration of about 25 to about 45 weight %.

12. The process of claim 2, wherein the aluminum chloride hexahydrate is dehydrated by:
contacting the hexahydrate with a melt comprising a chlorobasic mixture of at least one alkali metal chloride and aluminum chloride at a temperature within the range of about 160° C.-250° C. forming gaseous HCl and an oxychloroaluminate-containing reaction mixture;
contacting said reaction mixture with gaseous HCl at a temperature within the range of about 160° C.-250° C. to form and release water from the reaction mixture; and
recovering a melt enriched in aluminum chloride.

13. The process of claim 2, wherein the aluminum chloride hexahydrate is dehydrated by:
heating the aluminum chloride hexahydrate at 200° C.-450° C. decomposing the hexahydrate; and
reacting the decomposed hexahydrate with a chlorine containing gas at 350° C.-500° C. producing anhydrous aluminum chloride.

14. The process of claim 2, wherein the aluminum chloride hexahydrate is dehydrated by:
heating the hexahydrate at 100° C.-500° C. to remove water; and
heating this material at 600° C.-900° C. to producing anhydrous aluminum chloride.

15. The process of claim 1, further comprising the step of separating silica from the leachate.

16. The process of claim 1, further comprising the step of crushing the aluminum-bearing material prior to leaching.

17. The process of claim 16, wherein the aluminum-bearing material is crushed to an average particle size of about 50 to 80 μm.

18. The process of claim 16, further comprising the step of cycloning the crushed aluminum-bearing material.

19. The process of claim 16, further comprising the step of a magnetic separation of the crushed aluminum-bearing material.

20-22. (canceled)

23. The process of claim 1, wherein the aluminum-bearing material is at least one of bauxite, fly ash, scrap metal, clays, argillite, mudstone, beryl, cryolite, garnet, spinel, nepheline-syenites, nepheline-apatites, alunites, leucitic lavas, labradorites, anorthosites, kaolins, cyanitic, sillimanitic, mica and andalusitic schists.

24. (canceled)
